(19) United States
(12) Patent Application Publication
(10) Pub. No.: US 2007/0220550 A1
(43) Pub. Date: Sep. 20, 2007

(54) System and method for advertising on remote devices

(76) Inventors: Mikael Ljungman, Stockholm (SE); Hacan Akerberg, Stockholm (SE); David Levett, Los Angeles, CA (US)

Correspondence Address: MORRISON & FOERSTER, LLP, 555 WEST FIFTH STREET, SUITE 3500, LOS ANGELES, CA, 90013-1024, US

(21) Appl. No.: 11/544,221

(22) Filed: Oct. 6, 2006

(30) Foreign Application Priority Data
Feb. 17, 2006 (GB) 0603236.1

(51) Int. Cl. H04N 5/445; G06F 13/00; H04N 7/16; G06F 3/00

(52) U.S. Cl. 725/42; 725/62; 725/40; 725/43; 725/37

(57) ABSTRACT

The present invention is directed to a system and method for delivering advertisement messages to mobile communication devices. Specifically, in accordance with a preferred embodiment, advertisement messages are sent to mobile communication device in advance of a time an date on which the advertisement messages are to be presented on the mobile communication device. At the same time, signalling information is sent to the mobile communication devices for indicating to the mobile communication devices the time and date at which the advance sent advertisement messages are to be presented on the mobile communication device. The signalling information may include triggering events at which the advertisement message is to be presented.

### BACKGROUND

1. Field of Invention

The present invention relates to the insertion of pre-downloaded advertising content into streaming media (e.g., video and/or audio clips) delivered to a remote device (e.g., cell phones or PDAs) in response to a variety of triggers that determine the timing and choice of the inserted content.

2. Description of the Related Art

Although advertising is a widely accepted means for generating revenue from content delivered to an individual or group, many conventional approaches that embed advertising into a broadcast stream at the broadcast source tend to limit the ability to personalize and/or accurately target the individuals receiving the content.

Possibly the most common approach to embedding advertising into streamed or broadcasted content is that used by commercial radio and television stations sent over the air by terrestrial or satellite transmitters and through wired broadcasts such as cable TV.

The advent of increased bandwidth capabilities of cellular phone devices has provided additional possibilities for delivering broadcast content to remote devices though this is most often treated as an additional distribution medium for traditional television content.

The Internet, in conjunction with web browsers and media players, has enabled an additional choice in on-demand streamed content delivery, often with greater flexibility than traditional broadcast approaches. However, due to the transient nature of viewers in this medium, many providers of streamed content have chosen to front load the content with advertising that is streamed to the recipient prior to the delivery of the desired content.

A common disadvantage of traditional approaches to embedding advertising in streamed content is that the same advert is presented to all recipients. This has usually been justified on the basis that the content itself sufficiently defines the demographic of the recipient to validate the expense incurred by the advertiser.

Although considerations have been made as to means for delivering uniquely targeted advertising to each individual, existing broadcasting approaches typically do not have the technical means to deliver different adverts to different recipients as part of a stream of content. In fact, as the number of recipients approaches the millions, systems that would seek to personalize content uniquely to each user income prohibitively expensive and untenable as a solution.

A further disadvantage of current approaches is that in order to deliver advertising that appeals to the broad demographic that may be receiving the content stream, broadcasters typically stream a series of often unrelated adverts in what is termed an ‘Ad Break’ only some of which are appropriate to an individual recipient. Conversely, since some of the adverts are inappropriate for a given recipient, the level of interest in a typical ‘Ad Break’ is substantially diminished resulting in the advertising being considered an unwelcome interruption into the content stream they have chosen to receive.

By more accurately delivering advertising to each individual the recipient is less likely to receive information that is of no interest to them and therefore is more likely to pay attention to the advertising content as well as consider it less intrusive.

What is needed is a cost effective means for delivering unique advertising to each individual without incurring significant expense over and above the traditional costs of broadcasting streamed content.

But more effectively delivering advertising broadcasters will be able to deliver less adverts at a higher value to the advertiser and thus generate similar or perhaps greater advertising revenue while at the same time delivering a better, less interrupted, service to their subscribers.

On a mobile phone or a web browser connected to the Internet, the quality of the broadcast content received is highly dependent on the available signal quality and bandwidth. By pre-loading the advertising on to the device, even at slower than real time speed, broadcasters can ensure that the advertising content presented to the recipient is of the highest quality regardless of the available bandwidth at the moment of broadcast. Since advertising revenue is the primary source of income for many of these broadcasters it would not be in their interest for advertisers to know that in many cases the adverts they have paid to be delivered arrive in a substantially lower quality form wherever signal levels are suboptimal. Ultimately the suboptimal delivery of adverts would have a significant devaluing effect on the rates they are willing to pay and hence, on the profitability of the broadcaster.

### SUMMARY OF THE PRESENT INVENTION

The present invention is predicated on the inventive insight that by providing a cost effective mechanism for delivering unique advertising to an individual recipient of streamed content, broadcasters will be able to offer a better service to their subscribers and simultaneously deliver higher value to their advertisers.

Rather than transmitting the same adverts to all recipients of a stream of broadcasted content, the present invention provides a cost effective system and method to deliver unique advertising to each recipient via their mobile communication device (e.g., a cell phone, PDA, or e-mail communication device such as a Blackberry).

Although the preferred embodiment delivers advertising media to recipient mediums such as web browsers and mobile phones, the present invention is equally applicable to any broadcast mechanism that has the capability to uniquely deliver content to each device even if such unique delivery mechanism does not have the bandwidth of its broadcast counterpart. For example, a uniquely addressable cable or satellite TV decoder box may, in accordance with an alternative embodiment, be used for downloading advertising content in advance of displaying/replaying the content. Alternatively, additional broadcast channels could be allocated solely for the purpose of delivering advertising in a form that can be stored for later playback.

In a first aspect of the invention there is a system that tracks the subscription of each recipient along with some details about each subscriber that will help the system to determine the relevance of individual advertising media to be sent to them. A variety of methods may be used to gather information about each subscriber for purposes of determining relevance of advertisement media to be delivered. For instance, U.S. Pat. No. 6,647,257 by Owensby, hereby incorporated by reference for background purposes, teaches a conventional method of collecting basic user demographic profile of each subscriber for purposes of matching relevant advertising media to be delivered to each subscriber.

In a second aspect of the present invention a system and a method is provided for causing advertising content to be delivered to the appropriate recipients prior to the broadcast/trigger moment upon which the advertising content will be replayed on the downloaded device.

In a third aspect of the present invention a system and a method is provided that causes a mobile communication device to receive advertising media content either in a pre-created form for on-demand delivery or as a live content stream. In either embodiment, provision is made to indicate, to the mobile communication devices that have received the advertising content, suitable point(s) in time when a particular advertising media should be presented, such as during natural pauses in play on a sports channel or at predetermined intervals during a television series episode that has previously been designed with ‘Ad Breaks’ in mind.

In a fourth aspect of the invention there is a system that archives pre-created content for later on demand delivery to a recipient.

In a fifth aspect of the invention a system is provided for delivering pre-created and/or live streaming content to a recipient. In the case of pre-created on demand content, the delivery system is capable of pausing the content stream sent to a device and triggering the remote presentation of an advert followed by a resumption in transmission. In the case of live delivery of content, triggers received from the content source as to when is an appropriate moment for displaying an advert are forwarded to the remote device and optionally, the live content that was missed could be archived in case a recipient wished to view content that would've been viewed had the stream not been interrupted.

### BRIEF DESCRIPTION OF THE DRAWINGS

FIG. 1 is a schematic illustration of a system for delivering advertising media to mobile communication devices in accordance with the preferred embodiment of the present invention;

FIG. 2 is a flow chart illustrating a method of delivering advertising media content to mobile communication devices in accordance with the preferred embodiment of the present invention; and

FIG. 3 is a flow chart illustrating a method of replaying advertising media content on mobile communication devices in accordance with the preferred embodiment of the present invention.

### DETAILED DESCRIPTION OF A PREFERRED IMPLEMENTATION

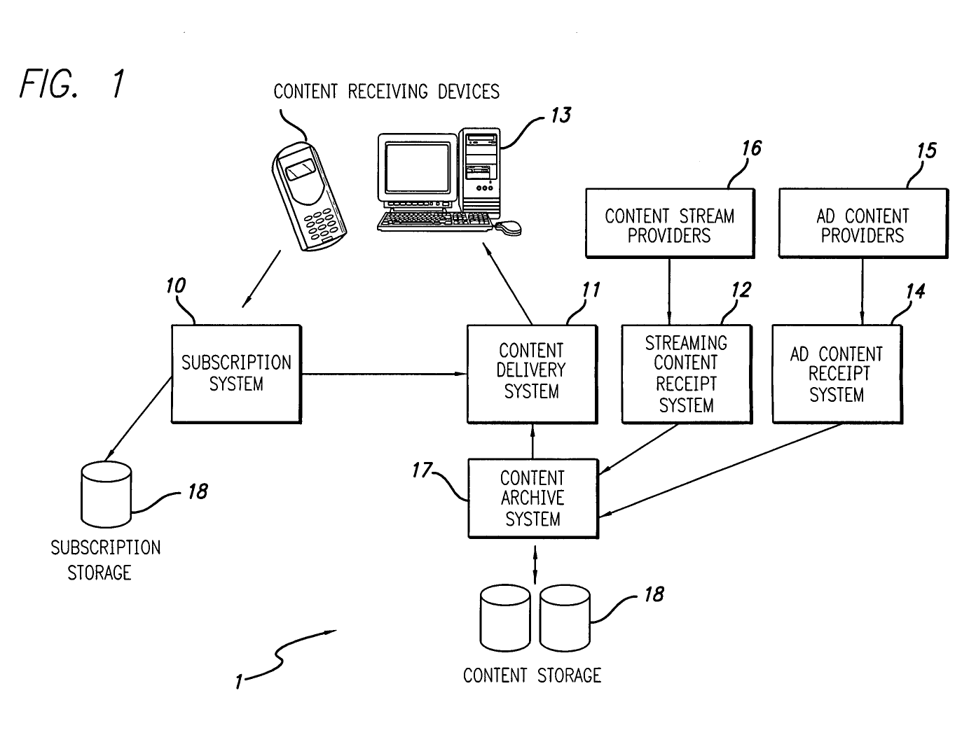

The present invention will be described with reference to the accompanying drawings, in which FIGS. 1 to 3 are schematics of the overall system architecture for delivering event triggered content in accordance with the present invention. Specifically, the preferred embodiment of the president invention will be described with reference to an implementation called the Remote Interstitial Advertising System (“RIAS”). The RIAS utilizes processes that are designed to deliver embedded advertising into live streaming content for users mobile communication devices, including laptop computers. It should be apparent to one skilled in the art that alternative embodiments of the present invention can be used for other forms of broadcast content such as cable or satellite television.

FIG. 1 Illustrates the key components of the over all system 1 in accordance with the preferred embodiment. Specifically, the subscription system 10 in accordance with the preferred embodiment provides a means for recording information about each subscriber/potential recipient such that the collected information can be used to determine the set of advertising media content most appropriate for an individual. Information relating to user subscriptions is preferably maintained in the subscriptions storage database 18.

The ad content receipt system 14 provides a means for receiving, from advertising content providers 15 (e.g., Coke Cola, Warner Brothers, Home Depot, etc.), advertising content along with corresponding description information suitable for identifying individual recipients who are ideal targets for receiving the content. The streaming content receipt system 12 accepts, from content stream providers (e.g., ESPN, ABC, HBO, etc.), content in a form that is preferably ready for broadcasting along with signaling information that identifies appropriate points at which advertising can be inserted. In accordance with the preferred embodiment, the streaming content receipt system 12 is capable of accepting live and pre-created content.

With further reference to FIG. 1, the content delivery system 11 transmits content, preferably via content stream, stream to the remote devices. In accordance with the preferred embodiment, signaling information for identifying when an advertisement media content should be presented is transmitted along with the content stream. In the case of a live content stream, the delivery system 11 preferably cache real-time content for the duration of the playback of an advertisement media in order to allow the recipient the potential for replaying live content that was missed during the playback of an advertisement media.

In accordance with the preferred embodiment, signaling information may be embedded in the content itself (e.g., an object tag), or to a signal sent as a schedule in advance of sending the content. The signaling information may also be sent concurrently with the content via a separate channel; Signaling information embedded within the content itself have the added advantage of, in certain instances, triggering advertisements within the content if viewed offline.

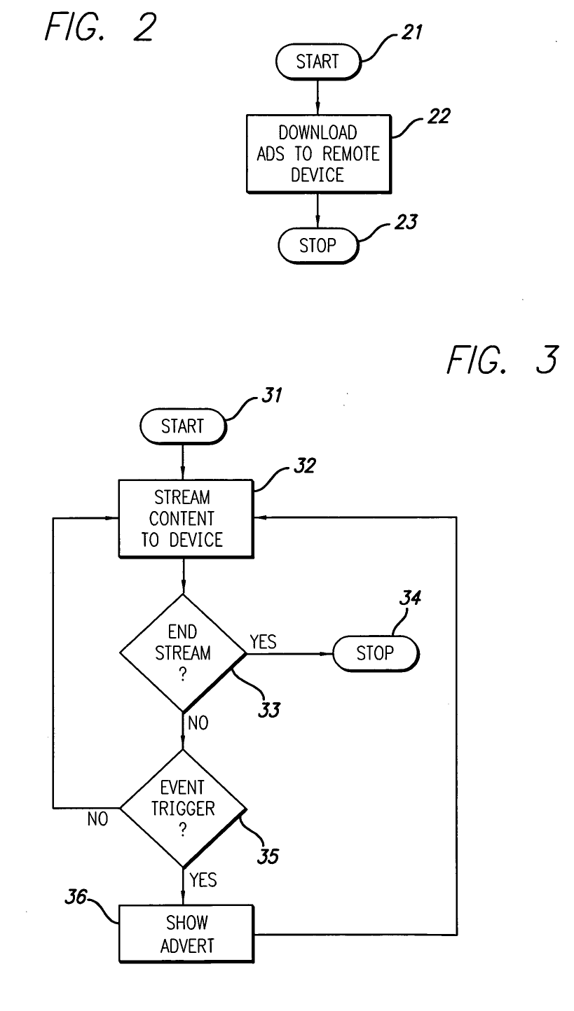

Advertisement media that have been uploaded to the ad content receipt system 14 and match the profile of an individual recipient is downloaded onto the remote device, preferably prior to the transmission of the live content during which the advertisement content is intended to be replayed. FIG. 2 illustrates in simple form the start 21, download, 22, and stop 23 steps of downloading advertising media to a remote communication device. Preferably, the download of advertising media takes place during times in which the remote communication device is predicted to be inactive (e.g., 3:00 a.m. to 6:00 a.m.).

In accordance with the preferred embodiment, software on the remote device is capable of selectively downloading advertising media content from a content deliver system. Specifically, the software preferably determines the cell phone's storage capacity to hold the compressed advertising media and controls the amount of advertising media that may be downloaded at any given time, taking into consideration of anticipated downloading of content media/streams.

FIG. 3 illustrates a method for delivering live content streams to a mobile communication device, along with the event information that triggers the replay of the pre-stored advertisement, in accordance with the preferred embodiment of the present invention.

Specifically, after the start 31, content that is received for transmission is forwarded 32 to each remote device that has been determined to be appropriate for receiving the content; the transmission of the content need not be simultaneous, and may take the form of broadcast, multicast, or unicast. In accordance with the preferred embodiment, triggering information received and stored by the streaming content receipt system 12 is used by the content delivery system 11 to determine when an advertisement should be replayed and whether it should pause pre-created content stored in its content archives or cache live data for the duration of the advertisement. At the same time, the trigger is preferably also forwarded to the remote device to cause it to interrupt 35 the content stream and display 36 an on-device advertisement.

Once the end of the content stream is received 34, the display of the content stream is stopped 34.

An advantage of the current approach is that it does not preclude the generic broadcast of advertising (e.g. as television) that instead allows for a configurable approach that combines some traditional ‘Ad Breaks’ along with individually targeted interstitial advertising.

In accordance with an alternative embodiment, feedback mechanisms from the remote device is included, via either hardware or software, that tracks/confirms which and when each downloaded advertisements were viewed, and that may receive from the user rating on the relevance/quality of the advertisement content received.

What we claim:

1. A method for delivering advertisement messages to mobile communication devices, said method comprising the steps of:
receiving, from an advertisement content provider, an advertising message;
receiving, from the advertisement content provider, at least one criteria under which the advertising message is to be presented;
transmitting the advertisement message to a plurality of mobile communication devices; and
transmitting signaling information to the plurality of mobile communication devices, said signalling information indicative of the at least one criteria under which the advertising message is to be presented.

2. The method of claim 1, wherein said signalling information is transmitted separately from the advertisement message.

3. The method of claim 1, wherein said advertisement message is a video clip.

4. The method of claim 1, wherein the at least one criteria for presenting the advertising message includes one of a date and time upon which the advertisement message is to be presented.

5. The method of claim 1, wherein the signalling information is transmitted to the mobile communication device on a communication channel separate from the advertisement message.

6. The method of claim 1, further comprising the step of storing the advertisement message.

7. The method of claim 1, further comprising the step of transmitting, to the mobile communication device, a multimedia content stream.

8. The method of claim 7, further comprising the steps of:
pausing the transmission of the multimedia content stream at a point at which the advertisement message is to be presented on the mobile communication device; and
resuming the transmission of the multimedia content stream after the advertisement message is presented on the mobile communication device.

9. The method of claim 7, wherein the advertisement message and the signalling information are transmitted prior the transmission of the multimedia content stream.

10. The method of claim 7, further comprising the steps of:
causing the mobile communication device to pause the presentation of the multimedia content stream;
causing the mobile communication device to present the advertisement message, said advertisement message being pre-stored in the mobile communication device; and
causing the mobile communication device to resume the presentation of the multimedia content stream after the advertisement message is presented.

11. The method of claim 10, wherein the mobile communication device temporarily stores the incoming multimedia content stream during when the presentation of the multimedia content stream is paused.

12. The method of claim 1, wherein said advertisement message is one of a text file, an audio file, a graphical file, and a video file.

13. The method of claim 1, wherein said at least one criteria specifies a trigger event upon which the advertisement message is to be presented.

14. A mobile communication device capable of selectively presenting advertising media, said mobile communication device having a display and a sound generator, said mobile communication device comprising:
means for receiving an advertisement message;
means for receiving signalling information, said signalling information including at least one criteria under which said advertisement message is to be presented; and
means for presenting the advertisement message in accordance with the at least one criteria.

15. The mobile communication device of claim 14, further comprising:
means for receiving multimedia content stream;
means for presenting the multimedia content stream; and
means for pausing the presentation of the multimedia content stream.

16. The mobile communication device of claim 15, wherein said advertisement message is presented during when the presentation of the multimedia content stream is paused.

17. The mobile communication device of claim 15, further comprising means for temporarily storing the incoming multimedia content stream during when the presentation of the multimedia content stream is paused.

18. The mobile communication device of claim 14, further comprising a memory for storing the advertisement message.

19. The mobile communication device of claim 14, wherein said at least one criteria specifies a trigger event upon which the advertisement message is to be presented.

20. The mobile communication device of claim 14, wherein said advertisement message is one of a text file, an audio file, a graphical file, and a video file.
